(19) United States
(12) Patent Application Publication
(10) Pub. No.: US 2026/0228021 A1
(43) Pub. Date: Aug. 6, 2026

(54) TECHNIQUES FOR STACKING IMAGES IN A GALLERY VIEW

(71) Applicant: Microsoft Technology Licensing, LLC, Redmond, WA (US)

(72) Inventors: Srinivasa Chaitanya Kumar Reddy GOPIREDDY, Lake Stevens, WA (US); John Robert Selbie, Kirkland, WA (US); Nuh Mohamed Mohamud, Seattle, WA (US); Jaimin Ajay Patel, Redmond, WA (US)

(21) Appl. No.: 19/043,358

(22) Filed: Jan. 31, 2025

(51) Int. Cl. G06F 9/451

(52) U.S. Cl. CPC G06F 9/451

(57) ABSTRACT

Described are examples for generating a stack of images for a gallery view in an image viewing application. Multiple slices of multiple images can be identified based on a timestamp associated with each of the multiple images. Within a given slice of the multiple slices of images, an embedding can be generated for each image. A portion of the multiple images within the given slice can be grouped into the stack of images based on comparing respective embeddings for the portion of images. A single top image representing the stack of images can be displayed in the gallery view.

### BACKGROUND

Modern day user devices, such as cellular phones, tablet devices, laptop or desktop computers, etc., come equipped with cameras for capturing images. In addition, various forms of standalone digital cameras exist as well to allow users to capture images. Systems have been developed that allow for cloud-based common storage or backup of images and/or other files from various devices of a user. Such storage systems can be managed by a service provider, which may provide account-based access to users to store and retrieve images and/or other files from the various devices associated with the user. The service provider may also provide an application for use by one or more user devices to retrieve or otherwise manage storage of the images and/or other files. In some cases, the application may be provided on a cellular phone or other device of the user, and may have a gallery view for viewing images stored by the user and/or user device(s). The gallery view may show, on a given display of an interface, thumbnails of each image stored by the user and/or user device(s), such that the user can scroll through the thumbnails, select an image for full screen (or otherwise enlarged) viewing, editing, and/or the like.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method for generating a stack of images for a gallery view in an image viewing application is provided. The method includes identifying, for multiple images displayed in the gallery view, multiple slices of the multiple images based on a timestamp associated with each of the multiple images, generating, within a given slice of the multiple slices of images, an embedding for each image in the given slice, grouping a portion of the multiple images within the given slice into the stack of images based on comparing respective embeddings for the portion of images, and displaying, in the gallery view, a single top image representing the stack of images.

In an aspect, a device for generating a stack of images for a gallery view in an image viewing application is provided. The device includes one or more memories storing instructions, and one or more processors coupled to the one or more memories. The one or more processors are configured to execute the instructions to identify, for multiple images displayed in the gallery view, multiple slices of the multiple images based on a timestamp associated with each of the multiple images, generate, within a given slice of the multiple slices of images, an embedding for each image in the given slice, group a portion of the multiple images within the given slice into the stack of images based on comparing respective embeddings for the portion of images to detect the respective embeddings of the portion of images as within a threshold difference, and display, in the gallery view and instead of displaying all images in the stack of images, a single top image representing the stack of images.

In an aspect, a non-transitory computer-readable medium storing instructions thereon that, when executed by at least one computing device, cause the at least one computing device to perform operations for generating a stack of images for a gallery view in an image viewing application is provided. The operation include identifying, for multiple images, multiple slices of the multiple images based on a timestamp associated with each of the multiple images, generating, within a given slice of the multiple slices of images, an embedding for each image in the given slice, grouping, based on displaying the multiple images in a gallery view, a portion of the multiple images within the given slice into the stack of images based on comparing respective embeddings for the portion of images, and displaying, in the gallery view, a single top image representing the stack of images.

In a further aspect, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a schematic diagram of an example of a device for performing functions related to generating stack information for images for display in a gallery view, in accordance with aspects described herein.

FIG. 2 illustrates examples of interfaces showing a gallery view that can be displayed by an image viewing application, in accordance with aspects described herein.

FIG. 3 is a flowchart of an example of a method for displaying stacked images in a gallery view, in accordance with aspects described herein.

FIG. 4 is a schematic diagram of an example of a device for performing functions described herein, in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes various examples related to stacking images having a threshold similarity in a gallery view. By stacking similar images, a single top image can be displayed in the gallery view to represent a group of similar images, which can reduce the number of images shown in the gallery view, and accordingly reduce clutter in displaying the images in the gallery view. To determine grouping for the images, the images can be sliced based on a timestamp of the images to reduce the number of images considered for a given group. For each slice, images can be grouped based on generating and comparing one or more embeddings for each of the images in the slice to determine embeddings that are within a threshold similarity. Grouping the images can include associating the images in a database table or other structure that can be subsequently queried to obtain the associations. In this regard, for example, when displaying the gallery view, the database table can be queried to obtain the associations, and the gallery view can stack grouped images in the gallery view display such that a single top image is displayed for the group of images, rather than displaying each image in the group of images.

In an example, for similar or grouped images, a centroid can be created. An image in the group that is closest to the centroid can be selected as the single top image. In another example, the application providing the gallery view can allow for selection, via an interface, of an image to be the single top image. In this example, based on selection of an image from the group of images (e.g., by a user using the interface), an indication of the selected image can be stored as the single top image for the group. For example, this information can be stored in the database table such that when displaying the gallery view, the database table can be queried to obtain the associations and the indication of the single top image, and the gallery view can stack grouped images in the gallery view and display the single top image to represent the group of images.

In addition, in some examples, certain functions described herein can be performed based on whether the application that displays the gallery view is active, is executing as a foreground or background process on an operating system, etc. In one example, the slices can be identified and/or the embeddings can be generated as the images are received or at certain times of day, as a user scrolls through images in the gallery view, etc. When the application moves to a background process, the embeddings for given images in a slice can be compared to detect groups of images based on similarity between embeddings, and grouping information can be stored. When the application moves to a foreground process, the grouping information can be retrieved and analyzed for form the image stacks in the gallery view. In these and various examples, the stacking is performed on the device executing the gallery view (or the application that provides the gallery view), which can be more efficient than a cloud-based process for stacking images. In addition, comparing the embeddings can use a weighted average for foreground and background embeddings, which can improve the efficacy of the stacking process. Moreover, selecting the closest image to the centroid as the top image can allow for selecting a top image that accurately reflects the group of images.

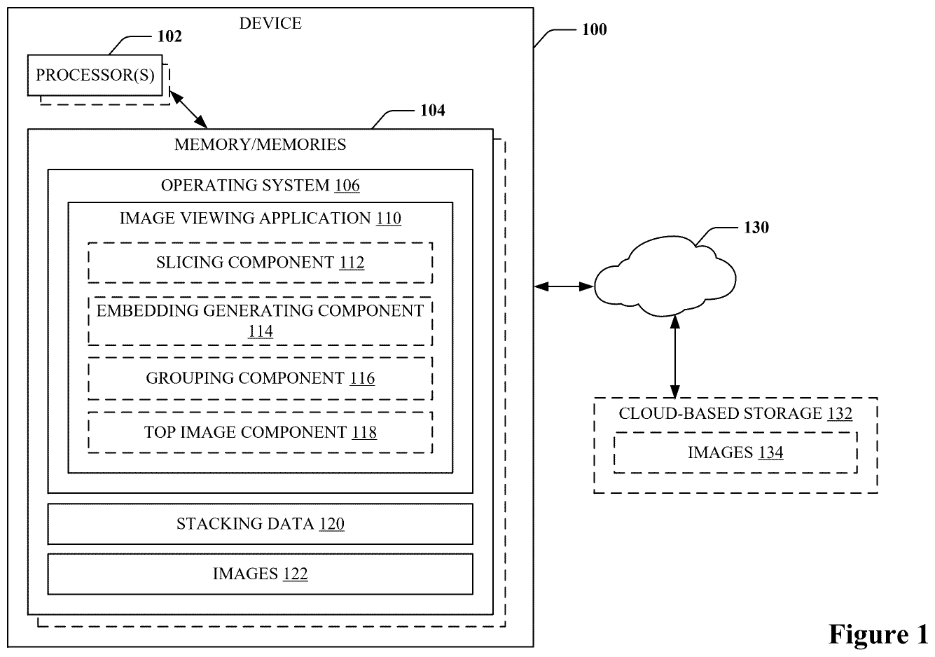

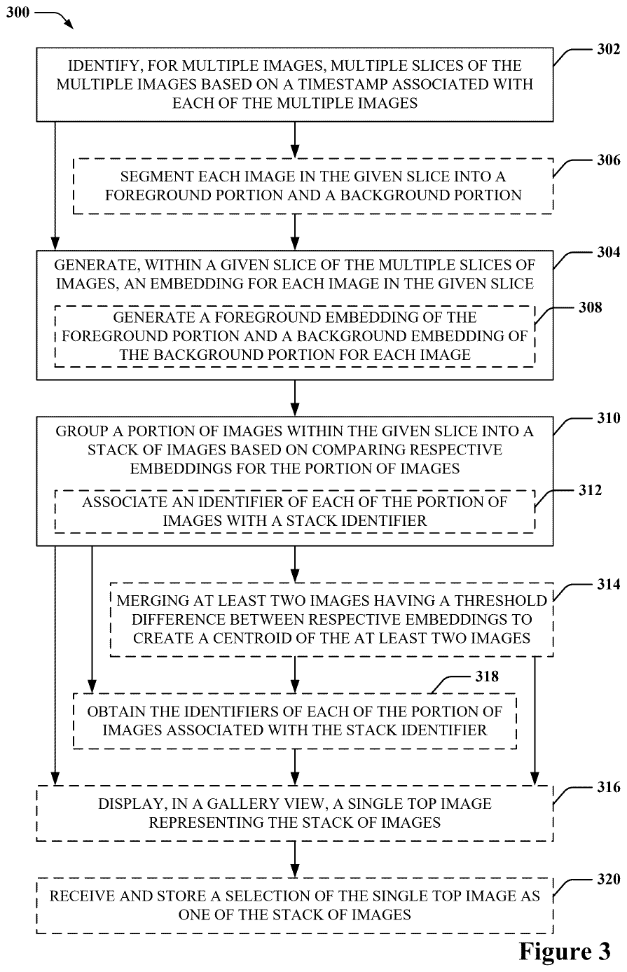

Turning now to FIGS. 1-4, examples are depicted with reference to one or more components and one or more methods that may perform the actions or operations described herein, where components and/or actions/operations in dashed line are generic and may be replaced with their variants. Although the operations described below in FIG. 3 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

FIG. 1 is a schematic diagram of an example of a device 100 (e.g., a computing device) for performing functions related to generating stack information for images for display in a gallery view, in accordance with aspects described herein. In an example, device 100 can include one or more processors 102 and/or memory/memories 104 configured to execute or store instructions or other parameters related to providing an operating system 106, which can execute one or more applications or processes. For example, processor(s) 102 and memory/memories 104 may be separate components communicatively coupled by a bus (e.g., on a motherboard or other portion of a computing device, on an integrated circuit, such as a system on a chip (SoC), etc.), components integrated within one another (e.g., processor(s) 102 can include the memory/memories 104 as an on-board component), and/or the like. Memory/memories 104 may store instructions, parameters, data structures, etc. for use/execution by processor(s) 102 to perform functions described herein. In another example, processor(s) 102 and/or memory/memories 104 can be distributed over multiple devices or physical computing nodes in a network (e.g., in a cloud-based computing platform) for providing the functions of the various components described herein.

In one example, the operating system 106 can execute one or more applications or processes, such as, but not limited to, an image viewing application 110 for displaying images stored for or by a user in a gallery view, where the gallery view can include multiple thumbnails of images displayed on a single visible interface, and can allow user interaction with each thumbnail to display an image corresponding to the thumbnail in an enlarged or full-screen view on the interface. Image viewing application 110 can optionally include a slicing component 112 for slicing a collection of images into different slices based on a time stamp. Image viewing application 110 can optionally include an embedding generating component 114 for generating, for each image in a given slice of images, one or more embeddings based on the image data (e.g., based on pixel values of pixels in the image, based on other data or tags associate with the image, etc.). Image viewing application 110 can optionally include a grouping component 116 for grouping images based on similarity between embeddings, where information of the groups can be stored in stacking data 120. Image viewing application 110 can optionally include a top image component 118 for selecting a top image to represent a stack of a given group of images for displaying in the image viewing application 110.

In an example, image viewing application 110 can obtain images related to a user account using the image viewing application 110 from a local memory (e.g., memory/memories 104), such as images 122, which may be cached on the device 100. In an example, image viewing application 110 can obtain images related to a user account using the image viewing application 110 from a cloud-based storage 132 associated with the image viewing application 110, such as images 134. For example, device 100 can access cloud-based storage 132 via one or more network 130, which may include the Internet. In one example, when the image viewing application 110 is executed or operated by the device 100, image viewing application 110 can obtain at least a portion of images 134 stored on the cloud-based storage 132 for caching on the device 100 in memory/memories 104 as images 122. In an example, image viewing application 110 can display images in chronological order (e.g., from most recent to least recent) based on a timestamp associated with the images, and in an example, image viewing application 110 can obtain a portion of images 134 for caching based on a period of time for which images are requested for being displayed by the image viewing application 110.

For a set of images, slicing component 112 can identify slices of the set of images based on a timestamp associated with the images. For example, slicing component 112 can create slices of images based on the day of capture for the images (e.g., the day the images were created by a camera or other device). In another example, slicing component 112 can create slices of images based on time differences between any two images (e.g., time difference between the time of capture for the images). Various mechanisms for slicing the set of images can be possible to reduce the number of images being compared for grouping images. For example, slicing component 112 can slice the set of images (e.g., cached images 122) per day in chronological order. If the number of images in the slice (or on the given day) exceeds a threshold (e.g., a configurable threshold, such as 100 images), slicing component 112 can further slice the set of images based on another measure of time (e.g., a slice for an hour) or otherwise, so that no slice exceeds the threshold number of images. In another example, or if the number of images in the slice (e.g., for an hour) still exceeds the threshold, slicing component 112 can further slice the images as a certain number of images that are adjacent in time (e.g., up to 20 adjacent images can form a slice).

In an example, once the slices are created, embedding generating component 114 can generate embeddings for each image in a given slice of images. In another example, embedding generating component 114 can generate embeddings for images before slicing component 112 slices the images, and/or slicing component 112 can slice the images based on the embeddings. For example, where a slice has more than a threshold number of images, slicing component 112 can further slice based on comparing the embeddings of images in the slice. For example, if a slice has more than the threshold number of images, slicing component 112 can compare a number of adjacent images (e.g., 20 images) and can form a slice of images that have embeddings that are within a threshold similarity (e.g., images whose embeddings are within a threshold difference of one another).

In an example, embedding generating component 114 can generate, for each image 122 or each image in a given slice, an embedding of the entire image. In another example, embedding generating component 114 can generate, for each image 122 or each image in a given slice, multiple embeddings of the image, such as a foreground embedding of a foreground of the image or a background embedding of the background of the image. Either or each of the embeddings can be used for comparing to determine further slicing or grouping images, as described above and further herein. In an example, embedding generating component 114 can store the embedding(s) associated with each image in stacking data 120, which may include storing the embeddings with an identifier of the image (e.g., an identifier of the file or pointer or other location associated with the image stored in memory/memories 104). In addition, in an example, slicing component 112 can store slicing information in stacking data 120, which may include an identifier for the slice and/or a list of identifiers of images in the slice. Moreover, in some examples, slicing component 112 can identify the slices and/or embedding generating component 114 can generate the embeddings when the image viewing application 110 is (or based on the image viewing application 110) operating as a foreground processing on the operating system 106, when the image viewing application 110 stores (or based on the image viewing application 110 storing) the associated images in cache (such as when the image viewing application 110 displays the images as a user scrolls through the images/thumbnails, etc.

With the embeddings generated (and/or stored in stacking data 120), grouping component 116 can group the images into stacks of similar images based on comparing one or more embeddings of the images to detect images within a threshold similarity (e.g., images having a threshold difference in embedding value). Grouping component 116 can store, in stacking data 120, information of stacks of images having embeddings within a threshold similarity. For example, grouping component 116 can store an identifier for the stack along with a list of identifiers corresponding to the images in the stack. In one example, grouping component 116 can perform the comparisons for the embeddings when the image viewing application 110 is operating (or based on the image viewing application 110 operating) as a background process on the operating system 106.

Based on grouping component 116 generating a stack of images, top image component 118 can select one of the images in the group to be a single top image displayed in the gallery view to represent the stack of images. In one specific example, grouping component 116 can generate, for each group of images, a centroid of the group of images (e.g., a centroid embedding value), which grouping component 116 can also store in stacking data 120. Top image component 118 can select one of the images in the group of images that is closest to the centroid (e.g., the image having an embedding that has a lowest difference from the centroid) as the single top image. For example, top image component 118 can associate an identifier of the single top image (e.g., an identifier of the image, an index of the image in the stack, etc.) with the stack in stacking data 120.

With the groupings stored in stacking data 120, image viewing application 110 can display grouped images in a stack by displaying the single top image for the stack, as identified in the stacking data 120, and/or can display an indicator that the single top image represents a stack of multiple images. In an example, image viewing application 110 can display the images as a stack based on a configuration setting the image viewing application to stack or group similar images in displaying the images on an interface. Moreover, in an example, image viewing application 110 can display the stacks of images based on stacking data 120 when the image viewing application 110 is operating as a foreground process on operating system 106. Image viewing application 110 can display the stacks of images as the associated images are retrieved for display based on a chronological order (or other order) when called for a current view of the interface displayed by the image viewing application 110 (e.g., as the user scrolls through the images). Showing the stacks instead of all images in the group, in this regard, can improve user experience and/or declutter the interface when viewing similar images in the gallery view.

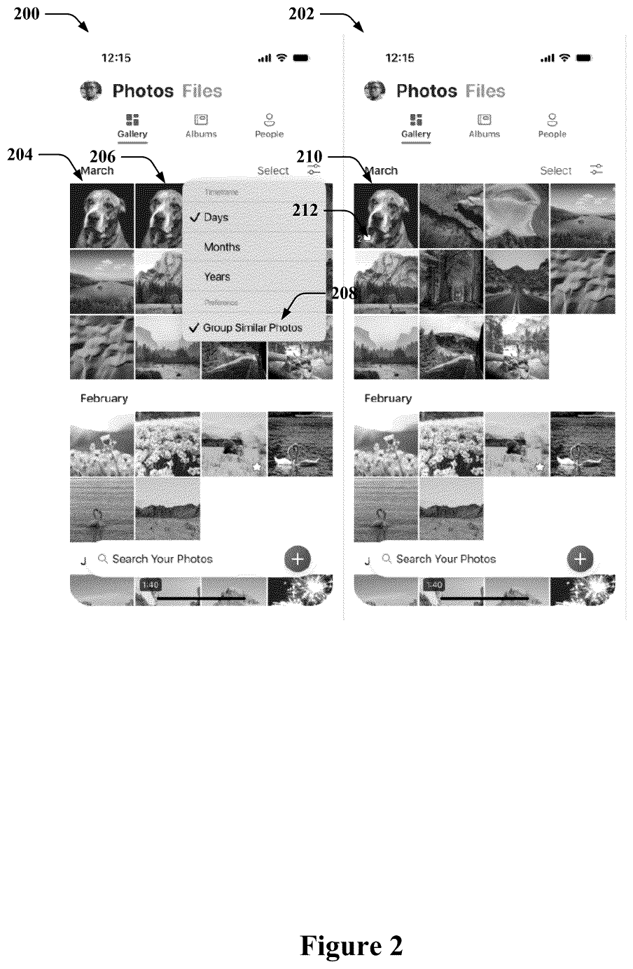

FIG. 2 illustrates examples of interfaces 200 and 202 showing a gallery view that can be displayed by an image viewing application 110, in accordance with aspects described herein. Interface 200 displays thumbnails of various images, including thumbnail images 204 and 206, which are chronologically sorted according to a time at which the image was captured (e.g., as a photograph from one or more user devices). In examples described herein, the image viewing application 110 can cache, slice, and/or generate embedding(s) associated with images represented by the thumbnails at the time the thumbnails are displayed on the interface 200, at the time the images are received or stored by the image viewing application 110, or during other times. In an example, image viewing application 110 can compare the embeddings to group images, which can occur when the image viewing application 110 moves to a background process on the operating system 106 or at other times. In one example, image viewing application 110 can group images based on selection of an option 208 to “Group Similar Photos.”

Based on comparing embeddings, image viewing application 110 can determine that images 204 and 206 are within a threshold similarity (e.g., that the embeddings of the images 204 and 206 are within a threshold difference) and can determine to group images 204 and 206 into a stack. As described, this can include image viewing application 110 selecting a top image for the stack as well (e.g., an image closest to a centroid of the images 204 and 206. Based on selection of the option 208 to group similar photos and/or based on the image viewing application 110 moving to a foreground process on the operating system 106, image viewing application 110 can obtain stored stacking data 120 and determine that the images 204 and 206 are stacked, and can display the single top image 210 instead of both images 204 and 206. In addition, image viewing application 110 can display an indicator 212 that the image 210 represents a stack of images. In an example, interaction with the single top image 210 (e.g., by a user using the interface 202) can cause display of one of images 204 or 206, a display of both images 204 and 206, and/or the like.

FIG. 3 is a flowchart of an example of a method 300 for displaying stacked images in a gallery view, in accordance with aspects described herein. For example, method 300 can be performed by a device 100 and/or one or more components thereof to facilitate stacking images in a gallery view, as described herein.

In method 300, at action 302, for multiple images, multiple slices of the multiple images can be identified based on a timestamp associated with each of the multiple images. In an example, slicing component 112, e.g., in conjunction with processor(s) 102, memory/memories 104, operating system 106, image viewing application 110, etc., can identify, for the multiple images, the multiple slices of the multiple images based on the timestamp associated with each of the multiple images. For example, the multiple images can be images for display, or being displayed, in a gallery view. Slicing component 112 can identify slices for images that are stored in cache (e.g., images 122), as the images are accessed by the image viewing application 110 (e.g., for display on an interface), as the images are captured by device 100, as the images are received by the device 100 (e.g., from one or more other user devices), and/or the like, as described.

Moreover, slicing component 112 can identify slices (e.g., chronologically) of a duration of time based on a timestamp of capture of the image, such as per day, per hour, etc., as described, which may be modified for slices having at least (or more than) a threshold number of images. Slicing component 112 can additionally or alternatively identify slices based on a number of images in a slice (e.g., slice the images once a certain number of images in the slice is reached. In an example, slicing can be a multi-step process, as described above, where further slicing can occur for slices having more than a threshold number of images and/or limited comparison of associated embeddings can occur based on configured thresholds to reduce the number of images being compared.

In method 300, at action 304, within a given slice of the multiple slices of images, an embedding can be generated for each image in the given slice. In an example, embedding generating component 114, e.g., in conjunction with processor(s) 102, memory/memories 104, operating system 106, image viewing application 110, etc., can generate, within the given slice of the multiple slices of images, the embedding for each image in the given slice. For example, embedding generating component 114 can generate one or more embeddings for an image based on determining that an embedding for the image is not stored in memory/memories 104. In addition, embedding generating component 114 can generate the embeddings by using an encoder to perform a feature extraction process to reduce image dimensionality to a lower latent space representation, such as an embedding, and/or to generate an image histogram indicating a number of pixels in an image as a function of intensity. In one example, embedding generating component 114 can use a machine learning (ML) model to generate an output of one or more embeddings based on the image as input to the ML model. Embedding generating component 114 can store the embedding(s) for each image in stacking data 120 for subsequent comparison.

In one example, in method 300, optionally at action 306, each image in the slice can be segmented into a foreground portion and a background portion. In an example, embedding generating component 114, e.g., in conjunction with processor(s) 102, memory/memories 104, operating system 106, image viewing application 110, etc., can segment each image in the slice into the foreground portion and the background portion. In this example, in generating the embeddings at action 304, optionally at action 308, a foreground embedding of the foreground portion and a background embedding of the background portion can be generated for each image. In an example, embedding generating component 114, e.g., in conjunction with processor(s) 102, memory/memories 104, operating system 106, image viewing application 110, etc., can generate the foreground embedding of the foreground portion and the background embedding of the background portion for each image. During comparison, in one example, described herein, the foreground and background embeddings may be separately considered or weighted for a more accurate similarity determination for the purposes of stacking images.

In method 300, at action 310, a portion of images within the given slice can be grouped into a stack of imaged based on comparing respective embeddings for the portion of images. In an example, grouping component 116, e.g., in conjunction with processor(s) 102, memory/memories 104, operating system 106, image viewing application 110, etc., can group the portion of images within the given slice into the stack of images based on comparing respective embeddings for the portion of images. For example, for each slice of images, grouping component 116 can compare the embeddings of the images to detect whether two or more images have an embeddings that is within a threshold similarity (e.g., less than a threshold difference). In one example, grouping component 116 can compute a cosine similarity between embeddings, and if the similarity is within a threshold, grouping component 116 can group the two or more images in a stack. In another example, grouping component 116 can compare tags generated by the images as features for weighted average comparison along with the embeddings, and can group two or more images in a stack based on comparing the tags and/or embeddings using weighted comparison. As described, in one example, grouping component 116 can separately compare, or compare using separate weights, a foreground embedding and background embedding of each image to determine whether similarity is within a threshold to result in stacking the images.

Grouping component 116 can continue comparing images until all images in the slice are compared (e.g., with all other images or at least one image in other stacks of images). For images grouped into the stack of images, grouping component 116 can store stacking information (e.g., in stacking data 120), which may include an identifier for the stack of images, an identifier of each image in the stack, and/or an identifier of an image in the stack to use as a single top image when displaying the stack of images in the gallery view. In grouping the portion of images at action 310, optionally at action 312, an identifier of each of the portion of images can be associated with a stack identifier. In an example, grouping component 116, e.g., in conjunction with processor(s) 102, memory/memories 104, operating system 106, image viewing application 110, etc., can associate an identifier of each of the portion of images with a stack identifier. Grouping component 116 can store stack information, including the stack identifier and each image identifier, in stacking data 120.

In one example, information for each image can be stored in an items database table, and grouping component 116 can store the information for each stack in a stacks database table. The items database table can include an identifier and file or memory location for each image on the user device (e.g., in images 122) or in cloud-based storage 132. Grouping component 116 can use the identifier from the items database table to identify images in associated stacks in the stacks database table. In an example, grouping component 116 can (e.g., periodically) query the stacks database table to fetch the last stored stack identifier, query the items database table and the stacks database table to fetch the items in the stack (e.g., by year month date), query the grouped items where there are more than two images, compare the embeddings of the images using cosine similarity, and store the embeddings, or related image identifiers, in stacks database table.

In method 300, optionally at action 314, at least two images having a threshold different between respective embeddings can be merged to create a centroid of the at least two images. In an example, grouping component 116, e.g., in conjunction with processor(s) 102, memory/memories 104, operating system 106, image viewing application 110, etc., can merge at least two images having a threshold difference between respective embeddings, using centroid logic, to create a centroid of the at least two images. In an example, grouping component 116 can store the centroid in stacking data 120 as well. Top image component 118 can use the centroid to determine a single top image for the stack of images as the image in the stack that is closest to (e.g., has the lowest difference in embedding from) the centroid. Top image component 118 can accordingly set the single top image for the stack, which can include storing, in the stacking data 120, an identifier or index of the image in the group that is to be used as the single top image for the stack.

In method 300, optionally at action 316, a single top image representing the stack of images can be displayed in a gallery view. In an example, image viewing application 110, e.g., in conjunction with processor(s) 102, memory/memories 104, operating system 106, etc., can display, in the gallery view, the single top image representing the stack of images. In this regard, image viewing application 110 can determine images that are stacked and the single top image to represent the stack (e.g., from stacking data 120) and can accordingly, at least on one interface, display single top images for stacked images instead of displaying all of the images in the stack (e.g., as shown on interface 202).

In method 300, optionally at action 318, the identifiers of each of the portion of images associated with the stack identifier can be obtained. In an example, image viewing application 110, e.g., in conjunction with processor(s) 102, memory/memories 104, operating system 106, etc., can obtain the identifiers of each of the portion of images associated with the stack identifier. For example, upon obtaining images for display in the gallery view, image viewing application 110 can query the stacking data 120 to determine stacks of images to be represented using a single top image. For example, image viewing application 110 can query the stacking data 120 based on a time period for images requested to be displayed, and can determine whether one or more requested images are in a stack. For a stack including a requested image, image viewing application 110 can receive, from the stacking data 120, the stack identifier, the identifiers of each image in the stack, the indicator of the single top image, etc. Image viewing application 110 can accordingly display the single top image from the group of images in the stack instead of displaying any other images having identifiers associated with the stack identifier. In addition, as described, image viewing application 110 can display an indicator that the single top image is representing a stack of images.

In method 300, optionally at action 320, a selection of the single top image as one of the stack of images can be received and stored. In an example, top image component 118, e.g., in conjunction with processor(s) 102, memory/memories 104, operating system 106, image viewing application 110, etc., can receive and/or store the selection of the single top image as one of the stack of images. For example, image viewing application 110 can provide an interface for displaying images in a given stack, and can allow for selection (e.g., by a user interacting with the interface) of a different top image for the stack. Top image component 118 can receive an indication of the selected top image (e.g., as an image identifier, an index of the image in the group of images in the stack, etc.) and can store the indicator of the selected top image in the stacking data 120, so that image viewing application 110 can display the selected top image when displaying stacked images.

In some examples, image viewing application 110 can allow other functions related to the stacked images, such as deletion of the entire stack of images (or all duplicates—e.g., other than the top image), creating an album of the stacked images, etc.

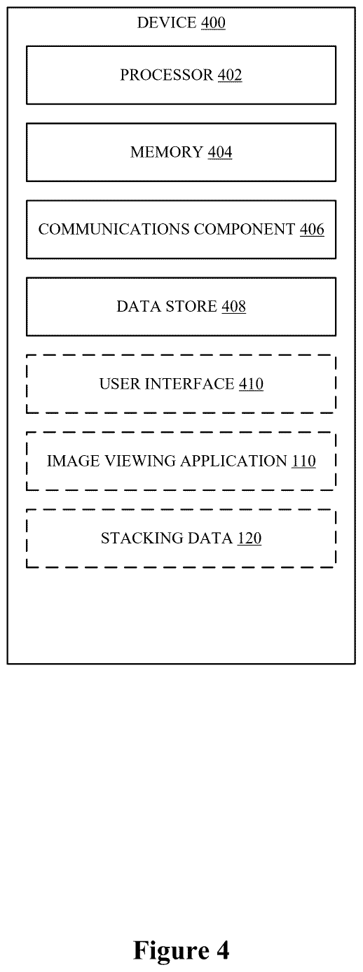

FIG. 4 illustrates an example of device 400 including additional optional component details as those shown in FIG. 1. In one aspect, device 400 may include processor 402, which may be similar to processor(s) 102 for carrying out processing functions associated with one or more of components and functions described herein. Processor 402 can include a single or multiple set of processors or multi-core processors. Moreover, processor 402 can be implemented as an integrated processing system and/or a distributed processing system.

Device 400 may further include memory 404, which may be similar to memory/memories 104 such as for storing local versions of operating systems (or components thereof) and/or applications being executed by processor 402, such as an image viewing application 110, corresponding data, such as stacking data 120, etc. Memory 404 can include a type of memory usable by a computer, such as random access memory (RAM), read only memory (ROM), tapes, magnetic discs, optical discs, volatile memory, non-volatile memory, and any combination thereof.

Further, device 400 may include a communications component 406 that provides for establishing and maintaining communications with one or more other devices, parties, entities, etc. utilizing hardware, software, and services as described herein. Communications component 406 may carry communications between components on device 400, as well as between device 400 and external devices, such as devices located across a communications network and/or devices serially or locally connected to device 400. For example, communications component 406 may include one or more buses, and may further include transmit chain components and receive chain components associated with a wireless or wired transmitter and receiver, respectively, operable for interfacing with external devices.

Additionally, device 400 may include a data store 408, which can be any suitable combination of hardware and/or software, that provides for mass storage of information, databases, and programs employed in connection with aspects described herein. For example, data store 408 may be or may include a data repository for operating systems (or components thereof), applications, related parameters, etc.) not currently being executed by processor 402. In addition, data store 408 may be a data repository for image viewing application 110, and/or one or more other components of the device 400, for storing data such as stacking data 120, etc.

Device 400 may optionally include a user interface component 410 operable to receive inputs from a user of device 400 and further operable to generate outputs for presentation to the user. User interface component 410 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 410 may include one or more output devices, including but not limited to a display, a speaker, a haptic feedback mechanism, a printer, any other mechanism capable of presenting an output to a user, or any combination thereof.

Some further example aspects are provided below.
Aspect 1 is a method for generating a stack of images for a gallery view in an image viewing application including identifying, for multiple images displayed in the gallery view, multiple slices of the multiple images based on a timestamp associated with each of the multiple images, generating, within a given slice of the multiple slices of images, an embedding for each image in the given slice, grouping a portion of the multiple images within the given slice into the stack of images based on comparing respective embeddings for the portion of images, and displaying, in the gallery view, a single top image representing the stack of images.
In Aspect 2, the method of Aspect 1 includes where identifying the multiple slices and generating the embedding for each image is performed based on displaying the multiple images as individual images in the gallery view.
In Aspect 3, the method of any of Aspects 1 or 2 includes where grouping the portion of images into the stack of images is performed based on the image viewing application moving to a background process on an operating system.
In Aspect 4, the method of any of Aspects 1 to 3 includes where grouping the portion of the multiple images includes associating, in a database table, an identifier of each of the portion of images with a stack identifier, and where displaying the single top image in the gallery view is based on querying the database table, based on the image viewing application moving to a foreground process on an operating system, to obtain the identifiers of each of the portion of images associated with the stack identifier.
In Aspect 5, the method of any of Aspects 1 to 4 includes segmenting each image in the given slice into a foreground portion and a background portion, where generating the embedding for each image includes generating a foreground embedding of the foreground portion and a background embedding of the background portion, and where grouping the portion of the multiple images is based on comparing respective foreground embeddings and respective background embeddings for the portion of images.
In Aspect 6, the method of any of Aspects 1 to 5 includes where grouping the portion of images into the stack of images is further based on comparing tags generated by the portion of images as features.
In Aspect 7, the method of any of Aspects 1 to 6 includes merging, before grouping the portion of the multiple images, at least two images having a threshold difference between respective embeddings, to create a centroid of the at least two images.
In Aspect 8, the method of Aspect 7 includes where the single top image is one image of the stack of images having the embedding that is closest to the centroid.
In Aspect 9, the method of any of Aspects 1 to 8 includes where identifying the multiple slices includes identifying each of the multiple slice based on a day of capture for each of the multiple images.
In Aspect 10, the method of any of Aspects 1 to 9 includes where identifying the multiple slices includes identifying each of the multiple slices based on a time of capture for each of the multiple images being within a threshold span of time.
In Aspect 11, the method of any of Aspects 1 to 10 includes receiving and storing a selection of the single top image as one of the stack of images.
Aspect 12 is an apparatus including one or more processors, one or more memories coupled with the one or more processors, and instructions stored in the one or more memories and operable, when executed by the one or more processors, to cause the apparatus to perform any of the methods of Aspects 1 to 11.
Aspect 12 is an apparatus for including means for performing any of the methods of Aspects 1 to 11.
Aspect 13 is one or more computer-readable media including code executable by one or more processors, the code including code for performing any of the methods of Aspects 1 to 11.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly included and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A computer-implemented method for generating a stack of images for a gallery view in an image viewing application, comprising:
identifying, for multiple images displayed in the gallery view, multiple slices of the multiple images based on a timestamp associated with each of the multiple images;
generating, within a given slice of the multiple slices of images, an embedding for each image in the given slice;
grouping a portion of the multiple images within the given slice into the stack of images based on comparing respective embeddings for the portion of images, wherein grouping the portion of the multiple images includes associating, in a database table, an identifier of each of the portion of images with a stack identifier; and
displaying, in the gallery view, a single top image representing the stack of images, wherein displaying the single top image in the gallery view is based on querying the database table, based on the image viewing application moving to a foreground process on an operating system, to obtain the identifiers of each of the portion of images associated with the stack identifier.

2. The computer-implemented method of claim 1, wherein identifying the multiple slices and generating the embedding for each image is performed based on displaying the multiple images as individual images in the gallery view.

3. The computer-implemented method of claim 1, wherein grouping the portion of images into the stack of images is performed based on the image viewing application moving to a background process on an operating system.

4. The computer-implemented method of claim 1, further comprising segmenting each image in the given slice into a foreground portion and a background portion, wherein generating the embedding for each image includes generating a foreground embedding of the foreground portion and a background embedding of the background portion, and wherein grouping the portion of the multiple images is based on comparing respective foreground embeddings and respective background embeddings for the portion of images.

5. The computer-implemented method of claim 1, wherein grouping the portion of images into the stack of images is further based on comparing tags generated by the portion of images as features.

6. The computer-implemented method of claim 1, further comprising merging at least two images in the portion of images, having a threshold difference between respective embeddings, to create a centroid of the at least two images.

7. The computer-implemented method of claim 6, wherein the single top image is one image of the stack of images having the embedding that is closest to the centroid.

8. The computer-implemented method of claim 1, wherein identifying the multiple slices includes identifying each of the multiple slices based on a day of capture for each of the multiple images.

9. The computer-implemented method of claim 1, wherein identifying the multiple slices includes identifying each of the multiple slices based on a time of capture for each of the multiple images being within a threshold span of time.

10. The computer-implemented method of claim 1, further comprising receiving and storing a selection of the single top image as one of the stack of images.

11. A device for generating a stack of images for a gallery view in an image viewing application, comprising:
one or more memories storing instructions; and
one or more processors coupled to the one or more memories and configured to execute the instructions to:
identify, for multiple images displayed in the gallery view, multiple slices of the multiple images based on a timestamp associated with each of the multiple images;
generate, within a given slice of the multiple slices of images, an embedding for each image in the given slice;
group a portion of the multiple images within the given slice into the stack of images based on comparing respective embeddings for the portion of images to detect the respective embeddings of the portion of images as within a threshold difference, wherein grouping the portion of the multiple images includes associating, in a database table, an identifier of each of the portion of images with a stack identifier; and
display, in the gallery view and instead of displaying all images in the stack of images, a single top image representing the stack of images, wherein displaying the single top image in the gallery view is based on querying the database table, based on the image viewing application moving to a foreground process on an operating system, to obtain the identifiers of each of the portion of images associated with the stack identifier.

12. The device of claim 11, wherein the one or more processors are configured to execute the instructions to identify the multiple slices and generate the embedding for each image based on displaying the multiple images as individual images in the gallery view.

13. The device of claim 11, wherein the one or more processors are configured to execute the instructions to merge at least two images of the portion of images, having a threshold difference between respective embeddings, to create a centroid of the at least two images.

14. The device of claim 13, wherein the single top image is one image of the stack of images having the embedding that is closest to the centroid.

15. The device of claim 11, wherein the one or more processors are configured to execute the instructions to identify each of the multiple slices based on a day of capture for each of the multiple images.

16. The device of claim 11, wherein the one or more processors are configured to execute the instructions to receive and store a selection of the single top image as one of the stack of images.

17. A non-transitory computer-readable medium storing instructions thereon that, when executed by at least one computing device, cause the at least one computing device to perform operations for generating a stack of images for a gallery view in an image viewing application, comprising:
identifying, for multiple images, multiple slices of the multiple images based on a timestamp associated with each of the multiple images;
generating, within a given slice of the multiple slices of images, an embedding for each image in the given slice;
grouping, based on displaying the multiple images in a gallery view, a portion of the multiple images within the given slice into the stack of images based on comparing respective embeddings for the portion of images, wherein grouping the portion of the multiple images includes associating, in a database table, an identifier of each of the portion of images with a stack identifier; and
displaying, in the gallery view, a single top image representing the stack of images, wherein displaying the single top image in the gallery view is based on querying the database table, based on the image viewing application moving to a foreground process on an operating system, to obtain the identifiers of each of the portion of images associated with the stack identifier.

18. The non-transitory computer-readable medium of claim 17, wherein identifying the multiple slices and generating the embedding for each image is performed based on displaying the multiple images as individual images in the gallery view.

19. The non-transitory computer-readable medium of claim 17, wherein grouping the portion of images into the stack of images is performed based on the image viewing application moving to a background process on an operating system.

20. The non-transitory computer-readable medium of claim 17, the operations further comprising merging at least two images in the portion of images, having a threshold difference between respective embeddings, to create a centroid of the at least two images, wherein the single top image is one image of the stack of images having the embedding that is closest to the centroid.
